(19) United States
(12) Patent Application Publication
(10) Pub. No.: US 2026/0128936 A1
(43) Pub. Date: May 7, 2026

(54) DYNAMIC SUBBAND OPERATION WITH EXPANDED DEVICE BANDWIDTH SUPPORT

(71) Applicant: Cypress Semiconductor Corporation, San Jose, CA (US)

(72) Inventors: Rakesh Taori, McKinney, TX (US); Kiran Uln, Pleasanton, CA (US)

(73) Assignee: Cypress Semiconductor Corporation, San Jose, CA (US)

(21) Appl. No.: 19/268,087

(22) Filed: Jul. 14, 2025

Related U.S. Application Data
(60) Provisional application No. 63/716,858, filed on Nov. 6, 2024.
(60) Provisional application No. 63/803,197, filed on May 9, 2025.

(51) Int. Cl. H04L 27/26; H04L 5/00

(52) U.S. Cl. CPC H04L 27/26414; H04L 5/0094

(57) ABSTRACT

Methods and apparatuses of dynamic subband operation (DSO) are provided. A station (STA) device receives a subband switch control frame from an access point (AP). The subband switch control frame indicates a transition, by the STA device, to a secondary channel. In response to receiving the subband switch control frame, the STA device transitions from a primary channel to the secondary channel. The subband switch control frame indicates one or more channels in the secondary channel, and the one or more channels are a subset of total available channels in the secondary channel.

### CROSS-REFERENCE TO RELATED APPLICATIONS

This application claims priority to U.S. Provisional Patent Application No. 63/716,858, filed Nov. 6, 2024, and U.S. Provisional Patent Application No. 63/803,197, filed May 9, 2025, the disclosures of which is incorporated by reference in their entirety.

### TECHNICAL FIELD

The present disclosure relates generally to telecommunications, and more particularly, to dynamic subband operations (DSOs) with expanded device bandwidth support.

### BACKGROUND

In some wireless systems, such as those relating to the Institute of Electrical and Electronics Engineers (IEEE) 802.11 standards, an access point (AP) provides a wireless network for other devices, such as non-AP station (STA) devices, to receive and transmit data via wireless communications in certain frequency bands. An AP or an STA device usually has a maximum bandwidth that the AP or the STA device can support. For example, the IEEE 802.11 standards provide that an AP may support a bandwidth of up to 320 Mega Hertz (MHz), although in reality some APs and some STA devices can only support lower bandwidths. For example, some APs support up to 160 MHz and some STA devices support up to 20 MHz, 40 MHz, or 80 MHz.

### BRIEF DESCRIPTION OF THE DRAWINGS

The present disclosure is illustrated by way of example, and not by way of limitation, in the figures of the accompanying drawings in which like reference numerals refer to similar elements.

FIG. 1 is a diagram that illustrates example DSO operations involving an AP, an STA device that supports DSO (DSO STA), and another STA device that does not support DSO (Non-DSO STA).

FIG. 2 is a diagram that illustrates total channels available for DSO in a secondary channel, according to some implementations.

FIG. 3A is a diagram that illustrates a subset of total channels available for DSO in a secondary channel, according to some implementations.

FIGS. 3B-3D illustrate example DSO subband distributions that a DSO AP may configure for a DSO STA, according to some implementations.

FIG. 4 is a flowchart that illustrates a method of DSO, according to some implementations.

FIG. 5 is a signal diagram that illustrates communications between an AP and an STA device in DSO, according to some implementations.

### DETAILED DESCRIPTION

The following description sets forth numerous specific details such as examples of specific systems, components, methods, and so forth, in order to provide a good understanding of various implementations of the techniques described herein for DSOs with expanded bandwidth supported. It will be apparent to one skilled in the art, however, that at least some implementations may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

As described above, an AP and an STA device may support different maximum bandwidths. When the AP and the STA device communicate, the mismatch in bandwidth often leads to underutilization of the AP's available frequency resources. In view of this, DSO has been proposed to reduce bandwidth wastage by allowing an AP to dynamically indicate transmission opportunities to an STA device such that the STA device may transition to a frequency channel outside the STA device's operating channel.

DSO is a mechanism where a DSO STA (e.g., a non-AP STA that implements DSO) that has an operating bandwidth narrower than the DSO AP (e.g., an AP that implements DSO) can dynamically be allocated frequency resources outside of the DSO STA's current operating bandwidth, but within the DSO AP's basic service set (BSS) bandwidth, on a per transmission opportunity (TXOP) basis. For a DSO STA, the channel having a bandwidth equal to the STA's operating bandwidth and including the BSS primary channel (e.g., a 20-MHz channel for exchanging control messages with the DSO AP) is referred to as the primary subband or primary channel for the STA, while the channel(s) in the remaining BSS bandwidth is/are referred to as secondary channels/subbands. Also for the DSO STA, a channel having a bandwidth equal to the STA's operating bandwidth and lying outside of the STA's primary subband but within the BSS bandwidth is referred to as a DSO subband for that STA if the channel can be allocated resources by the DSO AP during a DSO frame exchange. For example, in a 160 MHz BSS, the secondary 80 MHz subband can be a DSO subband for an 80 MHz DSO STA. Likewise, in a 320 MHz BSS, one of the secondary 80 MHz subbands (which can be up to three) can be a DSO subband for an 80 MHz DSO non-AP STA.

Due to some constraints that are described later in this disclosure, existing DSO techniques apply only to APs that support bandwidths of 160 MHz or above and STA devices that support bandwidths of 80 MHz or above. Because of these restrictions, many STA devices with low bandwidth support, such as those that support bandwidths up to 20 MHz or 40 MHz, are unable to benefit from DSO when communicating with an AP that supports a higher bandwidth.

Aspects of the disclosure address the above-noted and other deficiencies by expanding the applicability of DSO to STA devices with low bandwidth support. According to some aspects, an STA device receives a subband switch control frame from an AP. The subband switch control frame indicates a transition, by the STA device, to a secondary channel. In response to receiving the subband switch control frame, the STA device transitions from a primary channel to the secondary channel (e.g., a DSO subband). The subband switch control frame indicates one or more channels (e.g., one or more DSO subbands) in the secondary channel, and the one or more channels are a subset of total available channels in the secondary channel. With one or more features as described in detail below, implementations of this disclosure overcome some restrictions on the applicability of DSO and advantageously improve the resource utilization efficiency in wireless communications.

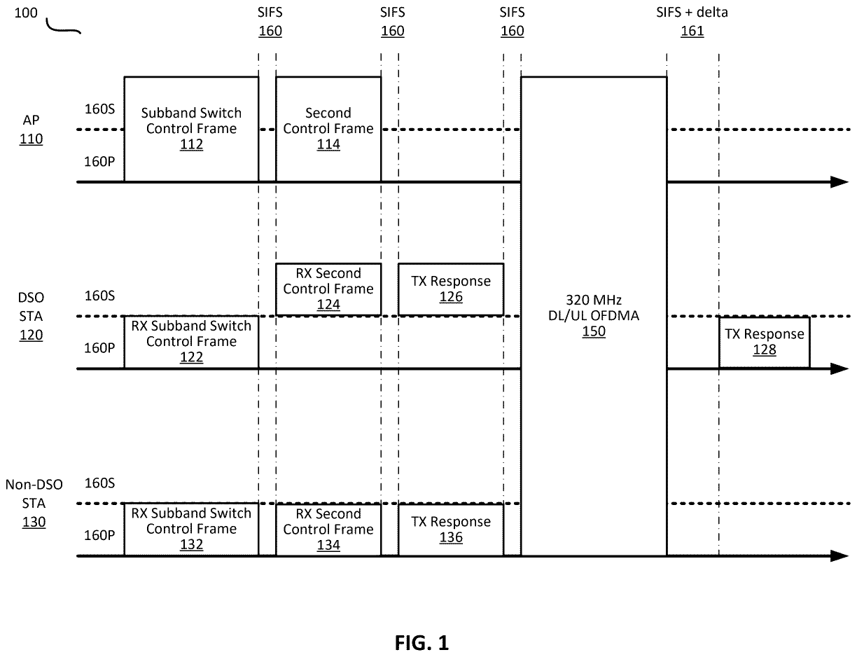

FIG. 1 is a diagram 100 that illustrates example DSO operations involving an AP 110, an STA device 120 that supports DSO (DSO STA), and another STA 130 device that does not support DSO (Non-DSO STA). In this example, AP 110 supports a maximum bandwidth of 320 MHz, while DSO STA 120 and Non-DSO STA 130 both support a maximum bandwidth of 160 MHz.

In general, a channel supported by a device, whether AP or STA, may be divided into a primary channel and one or more secondary channels. The primary channel is a division in which the BSS primary channel (usually a 20-MHz subband, denoted as Primary 20) for communicating control frames resides, and the one or more secondary channels are the remaining division(s). In the illustrated example, AP 110's bandwidth of 320 MHz is divided into a primary channel of 160 MHz, denoted as 160P or P160, and a secondary channel of 160 MHz, denoted as 160S or S160. In another example where a device supports a maximum bandwidth of 160 MHz, the bandwidth of 160 MHz may be likewise divided into a primary channel of 80 MHz, denoted as 80P or P80, and a secondary channel of 80 MHz, denoted as 80S or S80. The bandwidth division for devices supporting bandwidths of 80 MHz and 40 MHz may be similar to the divisions described above.

As illustrated, AP 110 sends subband switch control frame 112, such as an initial control frame (ICF), in the 320 MHz frequency channel (e.g., in one or more 20-MHz subbands of the 320 MHz channel) to an STA device initially operating in 160P. Depending on whether the STA device is a DSO STA or Non-DSO STA, the behaviors of the STA device are different.

For DSO STA 120, in response to receiving subband switch control frame 112 in 160P (e.g., in the 20-MHz primary subband), denoted as RX subband switch control frame 122, DSO STA 120 transitions to 160S according to DSO to continue communicating with AP 110. This way, AP 110 may use the frequency resources in 160P freed by DSO STA 120 to communicate with other devices. Conversely, for Non-DSO STA 130, in response to receiving subband switch control frame 112 in 160P, denoted as RX subband switch control frame 132, Non-DSO STA 130 remains in 160P due to non-support for DSO.

As also illustrated, AP 110 sends second control frame 114 in the 320 MHz frequency band. AP 110 sends second control frame 114 after subband switch control frame 112, with the two frames separated by short interframe spacing (SIFS) in time. SIFS is typically used to accommodate the switching time for a DSO STA, and, as described later, may be configurable according to the DSO STA's capability.

Having completed DSO, DSO STA 120 receives second control frame 114 in 160S, denoted as RX second control frame 124. DSO STA 120 further transmits (TX) response 126 to AP 110, also in 160S. Conversely, without performing DSO, Non-DSO STA 130 receives second control frame 114 in 160P, denoted as RX second control frame 134. Non-DSO STA 130 further transmits response 136 to AP 110, also in 160P.

AP 110 then communicates with each of DSO STA 120 and Non-DSO STA 130 by exchanging data and control signals in downlink (DL) and uplink (UL) traffic, which may include streams of orthogonal frequency division multiple access symbols. The communication with DSO STA 120 occupies 160S, while the communication with Non-DSO STA 130 occupies 160P. Once DSO STA 120 determines, either on its own or based on an instruction from AP 110, that DSO STA 120 no longer needs to operate in 160S, DSO STA 120 transitions back to 160P and transmits response 128 to AP 110. The transition back to 160P may take a time period of SIFS plus an offset, delta, to complete. On the other hand, Non-DSO STA 130 remains in 160P throughout the procedure.

In the example of FIG. 1, because DSO STA 120 supports a bandwidth of 160 MHz, DSO STA 120 has only one option for transitioning to a secondary channel of 160 MHz when communicating with AP 110 that supports 320 MHz. However, when a DSO STA has a lower bandwidth, the DSO STA has multiple options for the transition. For example, assuming a 320 MHz AP, a 20 MHz DSO STA has 15 channel choices for transitioning to the secondary channel, and a 40 MHz DSO STA has 7 channel choices for transitioning to the secondary channel. The large number of channel choices may lead to constraints on the applicability of DSO, as explained below.

As a first example, with the DSO STA having a large number of channel choices for DSO, the scheduling complexity is likely to increase considerably. It is possible that different DSO STAs have different DSO channel preferences, and the diverse channel preferences may increase scheduling complexity for the AP, especially when the different DSO STAs include a mix of STAs of different supported bandwidths (e.g., a mix of 20 MHz DSO STAs, 40 MHz DSO STAs, and 80 MHz DSO STAs).

As a second example, a DSO STA may perform a sounding procedure with the AP, and the sounding complexity increases as the number of channel choices for DSO increases. Each DSO channel may use a separate null data packet (NDP) or NDP announcement (NDPA) sounding sequence before the DSO operation, so a large number of DSO channel choices may lead to a large number of DSO sequences. Furthermore, DSO is often accompanied by beamforming, which adds to the complexity and time required for sounding.

As a third example, a DSO STA may need increased hardware and software capacity to accommodate the storage and processing needs for the large number of channel choices, such as storing channel state information for multiple bandwidths and handling multiple combinations of channel states.

As a fourth example, when there are both high performing DSO STAs (e.g., DSO STAs with large bandwidths and/or processing capacity) and low performing DSO STAs (e.g., DSO STAs with small bandwidths and/or processing capacity) in a network, the performance of the high performing DSO STAs may be burdened by the complexities associated with the AP's support for the low performing DSO STAs. It is thus challenging for the AP to perform load balancing on a network level in such situations.

In view of the constraints described above, existing technologies impose one or more of the following restrictions on DSO STAs.

As a first restriction, DSO is limited to APs with a minimum bandwidth of 160 MHz and STAs with a minimum bandwidth of 80 MHz. This restriction excludes devices with lower bandwidths.

As a second restriction, DSO is limited to the 5 giga-Hertz (GHz) and 6 GHz bands, which are typically for communications involving high performing APs and STAs. This restriction excludes devices that operate in the 2.4 GHz band.

As a third restriction, DSO is limited to devices in compliant with the IEEE 802.11bn (also known as Ultra High Reliability (UHR)) standard. This restriction excludes many devices designed based on earlier standards.

As a fourth restriction, a limited number of DSO subbands are supported depending on the BSS. For example, a 160 MHz BSS can have a secondary 80 MHz (80S) as a DSO subband, and a 320 MHz BSS can have a secondary 160 MHz as a DSO subband.

The restrictions on DSO are sometimes overly limiting and may hinder the technological development in some areas, such as the Internet-of-Things (IoT) devices, which often operate at low bandwidths and prioritize lower cost, small form factors, and low latency. Many of these devices are 20 MHz STA devices operating in the crowded 2.4 GHz band, which tends to suffer congestion. If less DSO restrictions were imposed on these STA devices, then the STA devices would be able to dynamically hop to a less congested channel, thereby reducing latency and improving reliability of the network. More generally, there is a need to expand the bandwidth support of DSO to a larger range of devices. Implementations that provide solutions to the need are described below.

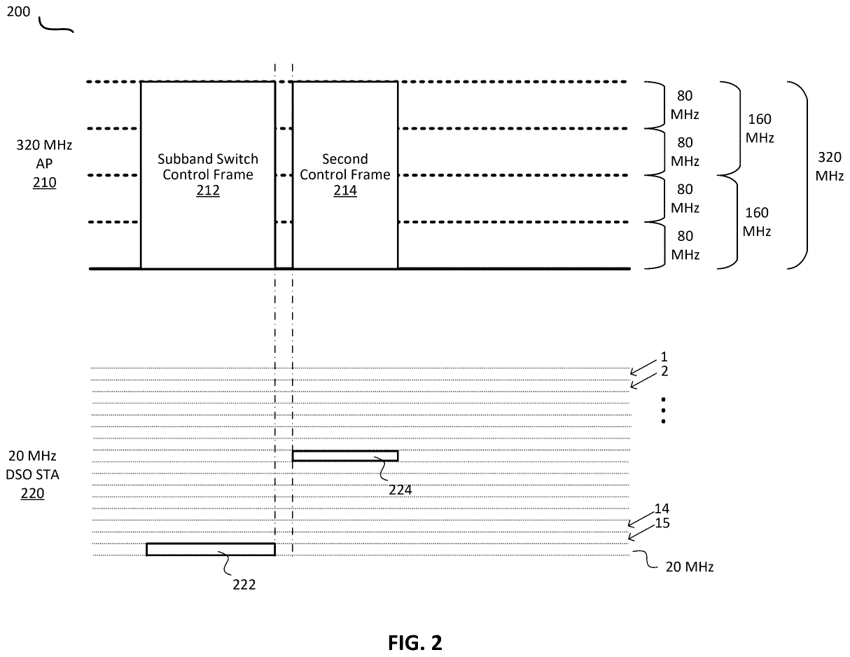

FIG. 2 is a diagram 200 that illustrates total channels available for DSO in a secondary channel, according to some implementations. Diagram 200 illustrates an example scenario in which a 320 MHz AP 210 is in communication with a 20 MHz DSO STA 220. AP 210's bandwidth of 320 MHz includes two divisions each having 160 MHz, and each division of 160 MHz further includes two divisions of 80 MHz.

As illustrated, AP 210 transmits subband switch control frame 212 followed by second control frame 214 in the 320 MHz bandwidth. DSO STA 220 receives subband switch control frame 212 in a primary 20 MHz bandwidth, denoted as RX subband switch control frame 222.

Subband switch control frame 212 indicates that DSO STA 220 should transition to the secondary channel, which may refer to a remaining 300 MHz frequency range within the 320 MHz bandwidth of AP 210. For DSO STA 220 of a 20 MHz bandwidth, the 300 MHz secondary channel includes a total of 15 available channels, numbered 1-15 in FIG. 2, each having a bandwidth of 20 MHz. DSO STA 220 may transition to one of the 15 available channels and receive second control frame 214 in that channel, denoted as RX second control frame 224.

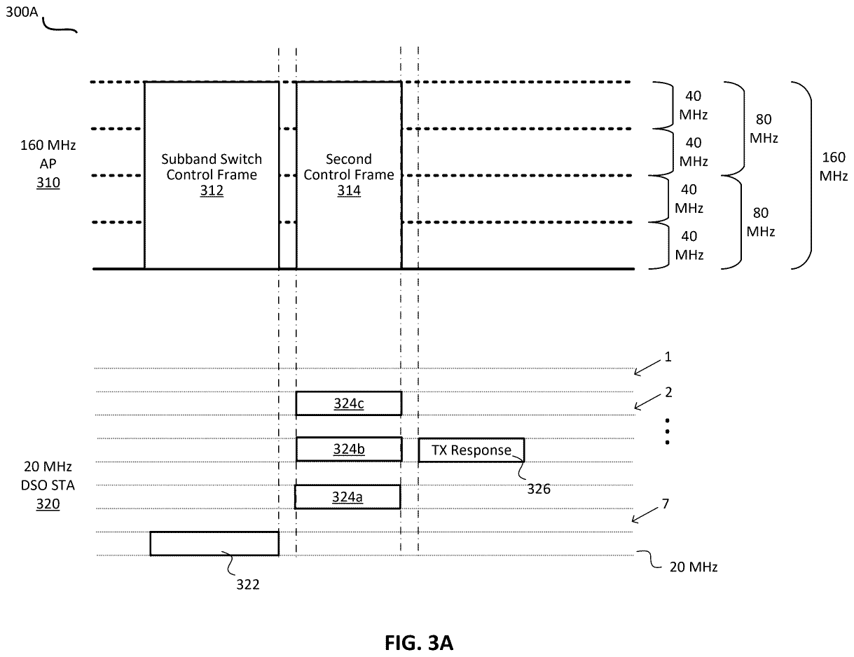

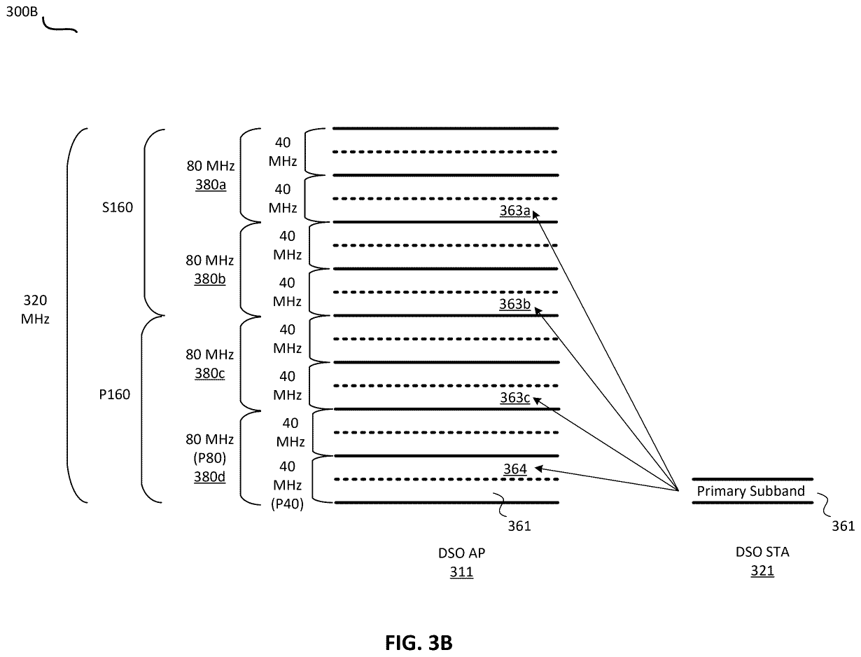

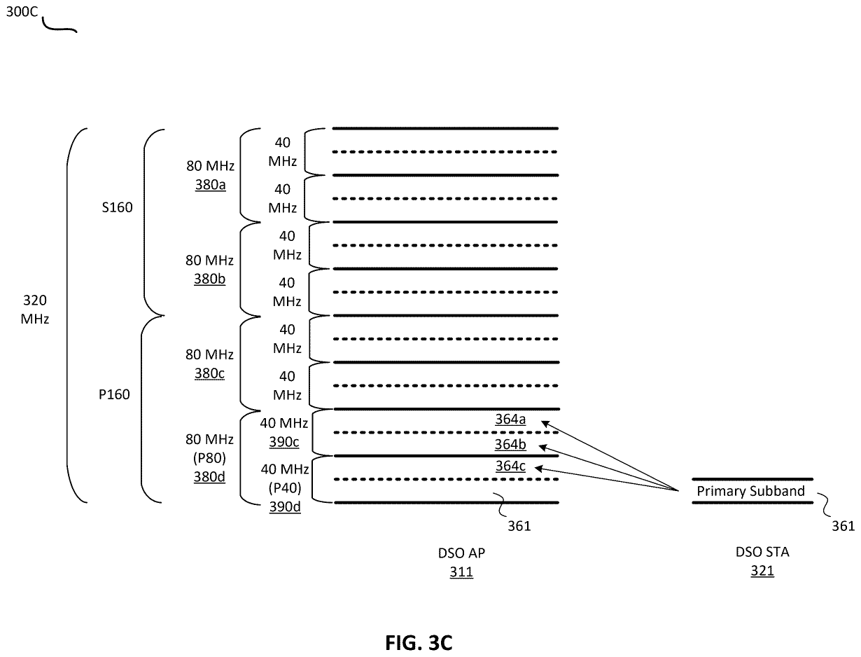

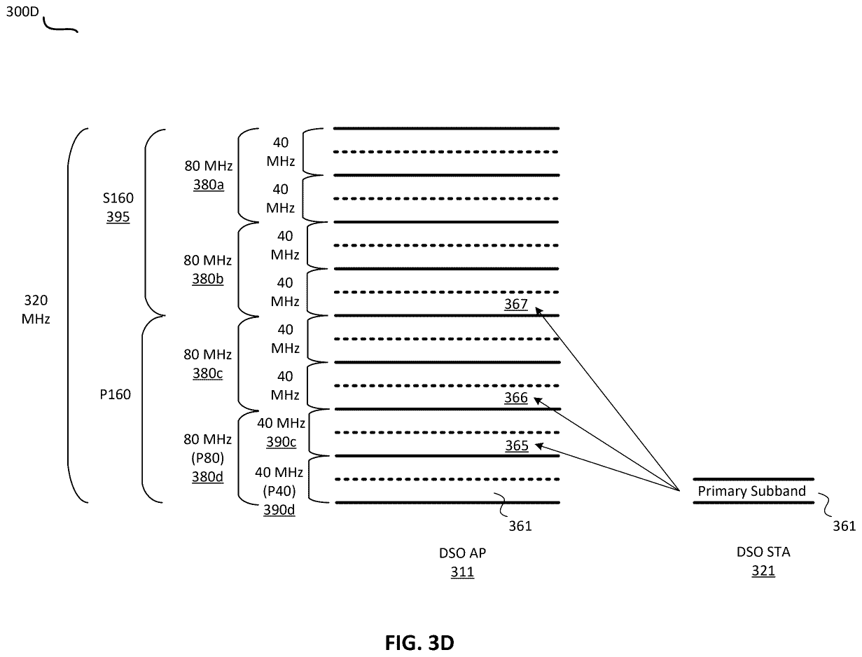

As described above, having a large number of channel choices for DSO may lead to complexity in some aspects, and that is a reason for imposing some DSO restrictions. To reduce the complexity while lessening the restrictions, the AP may use the subband switch control frame to indicate a subset of the total available channels that the DSO STA may transition to. An example scenario is illustrated in FIG. 3.

FIG. 3A is a diagram 300A that illustrates a subset of total channels available in a secondary channel for DSO, according to some implementations. In this example, AP 310 supports a maximum bandwidth of 160 MHz, while DSO STA 220 supports a maximum bandwidth of 20 MHz.

As illustrated, AP 310 transmits subband switch control frame 312 followed by second control frame 314 in the 160 MHz bandwidth (e.g., in a Primary 20 of the 160 MHz bandwidth). DSO STA 320 receives subband switch control frame 312 in a primary 20 MHz channel, denoted as RX subband switch control frame 322.

Subband switch control frame 312 indicates that DSO STA 320 should transition to the secondary channel, which may refer to a remaining 140 MHz frequency range within the 160 MHz bandwidth of AP 310. For DSO STA 320 of a 20 MHz bandwidth, the 300 MHz secondary channel includes a total of 7 available DSO subbands, numbered 1-7 in FIG. 3, each having a bandwidth of 20 MHz.

To reduce DSO complexity, subband switch control frame 312 indicates a subset of the total available DSO subbands in the secondary channel. As shown in FIG. 3, out of the 7 available DSO subbands, subband switch control frame 312 indicates that DSO STA 320 may transition to one of DSO subbands 324a, 324b, and 324c (collectively referred to as channels 324 or subband 324). For example, DSO STA 320 determines to transition to subband 324b to receive second control frame 314 from AP 310 and then transmit response 326 to AP 310 in the same subband 324b. Because the channel choices are reduced from a total of 7 to only 3,the complexity associated with DSO may be reduced.

An AP has multiple options of indicating the subset of total available subbands for a DSO STA to perform DSO, and may dynamically change the subset by sending update messages to the DSO STA. Several options are described below, although other options are possible.

In some implementations, the AP, knowing that the DSO STA is a 20 MHz or 40 MHz STA device, restricts the number of DSO subbands in the subset to be smaller than the number of total available channels. The AP may determine the number of channels in the subset based on load balancing needs, the DSO STA's processing capacity, network congestion level, and other factors. The AP may include this number along with channel configurations in a beacon, which is sent to the DSO STA prior to a network attach procedure between the DSO STA and THE AP. This way, the DSO STA may decide whether to attach to THE AP based on the number. The AP may also include this number along with channel configurations in a capability message to the DSO STA during or after the network attach procedure.

Alternatively or additionally, the AP determines the channels in the subset and informs the DSO STA of the determined channels. In some implementations, the AP determines the distribution of the channels (e.g., how the channels are distributed in the frequency domain) in the secondary channel according to a BSS associated with the DSO STA, such as based on the maximum bandwidth of the DSO STA that the BSS supports or intends to support. As an example, assuming the BSS intends to support a maximum bandwidth of 80 MHz, the AP may determine that the subset is limited to the primary 20 MHz bandwidth of each 80 MHz division of the AP's bandwidth. This approach reduces the choices of 20 MHz or 40 MHz DSO STAs and aligns the choices with other 80 MHz DSO STA's choices. This approach also avoid setting extra loads on the AP regardless of the number of 20 MHz and 40 MHz DSO STAs that the AP is serving.

Alternatively or additionally, the AP determines the distribution of the channels in the secondary channel according to a maximum bandwidth of the AP and a fixed number (e.g., 3), regardless of the maximum bandwidth of the DSO STA that the BSS supports or intends to support. For example, assuming the fixed number N is 3, a 320 MHz AP determines that a 20 MHz DSO STA can transition only among the primary 20 MHz channels of 4 (1 primary plus N=3 secondary) non-overlapping 320/4=80 MHz divisions of the total 320 MHz bandwidth. Under the same assumption, a 160 MHz AP determines that a 20 MHz DSO STA can transition only among the primary 20 MHz channels of 4 (1 primary plus N=3 secondary) non-overlapping 160/4=40 MHz divisions of the total 160 MHz bandwidth (such as the illustration in FIG. 3), and a 80 MHz AP determines that a 20 MHz DSO STA can transition only among the primary 20 MHz channels of 4 (1 primary plus N=3 secondary) non-overlapping 80/4=20 MHz divisions of the total 80 MHz bandwidth.

FIGS. 3B-3D illustrate example DSO subband distributions, 300B-300D, respectively, that a DSO AP may configure for a DSO STA, according to some implementations. In these examples, DSO AP 311 having an operating bandwidth of 320 MHz communicates with DSO STA 321 having an operating bandwidth of 20 MHz. The total bandwidth of 320 MHz may be viewed as having two 160-MHz divisions, and each 160-MHz division may be viewed as having two 80-MHz divisions, and so forth, making a total of 16 subbands each having a bandwidth of 20 MHz. Among these subbands is primary subband 361, which is the BSS primary channel of DSO STA 321. Although FIGS. 3B-3D illustrate primary subband 361 at an edge of the total 320-MHz bandwidth (i.e., having the lowest or the highest frequency value among all 16 subbands), it is possible for primary subband 361 to reside at other locations in the 320-MHz bandwidth.

Accordingly, the 160-MHz division that includes primary subband 361 is P160, while the other 160-MHz division that does not include primary subband 361 is S160. Within P160, the 80-MHz division that includes primary subband 361 is P80, while the other 80-MHz division that does not include primary subband 361 is S80. Likewise, within P80, the 40-MHz division that includes primary subband 361 is P40, while the other 40-MHz division that does not include primary subband 361 is S40.

As discussed previously, DSO AP 311 may configure DSO STA 321 with one or more channels (i.e., DSO subbands) that are less than the total number of channels in the operating bandwidth of DSO AP 311. Each of FIGS. 3B-3D illustrates an example distribution of DSO subbands in the 320-MHz bandwidth, although other distributions are possible. DSO AP 311 may determine the distributon of DSO subbands based on, e.g., the AP's evaluation of network or computing resources, the STA's request or indicated preference, or a combination of both.

In some implementations, the DSO AP may designate a 20-MHz subband within each division of secondary channels (e.g., each of the secondary 80 MHz divisions, each of the secondary 160 MHz divisions, or each of the secondary 160 MHz divisions) and treat this 20 MHz subband as a primary 20 MHz subband (P20) in that division. The DSO AP may then configure the DSO subbands to include the P20s of the secondary channel divisions.

In a first example illustrated in FIG. 3B, for 80 MHz divisions 380a -380c (each of which may be a DSO subband for an 80-MHz DSO STA in existing DSO techniques), DSO AP 311 designates subbands 363a -363c, respectively, as P20 in these divisions and configures subbands 363a -363c as DSO subbands for DSO STA 321. Alternatively or additionally, DSO AP 311 may configure subband 364, which is located immediately next to primary subband 361 in P80, as a DSO subband.

In the example of FIG. 3B, primary subband 361 is located at the bottom edge of division 380d. Meanwhile, the P20s (363a -363c ) of divisions 380a -380c are also located at the bottom edge of the respective divisions 380a -380c.

However, this is merely an example. The respective locations of a designated P20 in a secondary channel division may or may not be the same as the location of primary subband 361 in a corresponding same-sized primary channel division. For example, it is possible for DSO AP 311 to designate a 20-MHz subband having a different location in division 380a as a P20, and configure this 20-MHz subband as a DSO subband.

In a second example illustrated in FIG. 3C, DSO AP 311 configures the DSO subbands for DSO STA 321 to be limited within a primary channel division (e.g., P40, P80, or P160). As illustrated, DSO AP 311 configures subbands 364a -364c as DSO subbands, all of which are within the 80-MHz division 380d.

Alternatively, DSO AP 311 may further limit the configured DSO subbands to be within the 40-MHz division 390c (which is the secondary 40-MHz channel in P80), e.g., to include only subband 364b.

In a third example illustrated in FIG. 3D, DSO AP 311 configures the DSO subbands for DSO STA 321 to include the P20s in one or more secondary channel divisions of different bandwidths. As illustrated, the configured DSO subbands include subband 365, which DSO AP 311 designates as P20 of the secondary 40-MHz division 390c within P80. The configured DSO subbands alternatively or additionally include subband 366, which DSO AP 311 designates as P20 of the secondary 80-MHz division 380c within P160. The configured DSO subbands alternatively or additionally include subband 367, which DSO AP 311 designates as P20 of the secondary 160-MHz division 395 within the entire 320 MHz bandwidth.

The distribution examples described above with reference to FIGS. 3B-3D are non-limiting, and other distributions of DSO subbands are possible. For example, the DSO AP may configure the DSO subbands to include some or all of 20-MHz subbands (or 40-MHz subbands in case the DSO STA has a 40 MHz operating bandwidth) within S160, and/or include a secondary 20-MHz subbands in some or all of the 40-MHz divisions. DSO AP may determine the DSO subband distribution autonomously or based on indications from the DSO STAs.

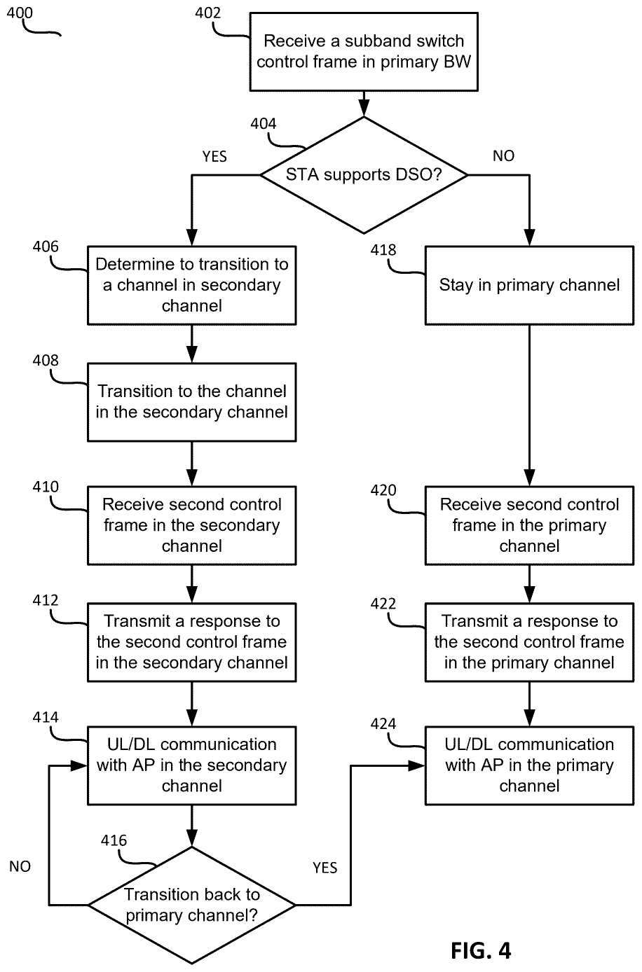

FIG. 4 is a flowchart 400 that illustrates a method of DSO, according to some implementations. The method may be performed by a STA device, such as DSO STA 120 or Non-DSO STA 130 in FIG. 1, DSO STA 220 in FIG. 2, or DSO STA 320 in FIG. 3. In some cases, the STA device may have a maximum bandwidth of 20 MHz or 40 MHz, not bound by one or more existing DSO restrictions.

At 402, the STA device receives a subband switch control frame, such as an ICF, in a primary channel from an AP. The subband switch control frame may instruct or request to STA device transition to a DSO subband that is other than the subband in which the STA is currently operating and may indicate one or more 20 MHz (in case of a 20 MHz STA) channels in the secondary channel (e.g., with a bandwidth of 80 or 160 MHz). As described above, the one or more channels are a subset of total available channels in the secondary channel.

At 404, the STA device determines whether the STA device supports DSO. If the STA device does not support DSO, then the method proceeds to 418 at which the STA device stays in the primary channel. If the STA device supports DSO, then the method proceeds to 406 at which the STA device determines to transition to a channel (e.g., a DSO subband) in the secondary channel. The STA device may determine the channel according to the indication in the subband switch control frame and/or according to the STA device's own configurations or preferences.

The STA device then receives a second control frame and transmits a response. If the STA device does not support DSO, then the STA device receives the second control frame in the primary channel at 420 and transmits the response also in the primary channel at 422. If the STA device supports DSO, then the STA device receives the second control frame in the secondary channel at 410 and transmits the response also in the secondary channel at 412. The STA device then performs UL or DL communications with the AP, either in the primary channel at 414 if the STA device supports DSO or in the secondary channel at 424 if the STA device does not support DSO.

In some implementations, the STA device communicating in the secondary channel determines whether to transition back to the primary channel at 416. The STA device may make the determination autonomously or based on an update message from the AP. If the STA device makes the determination, then the method proceeds to 424 at which the STA device transitions to the primary channel to communicate with the AP. If the STA device makes the determination, then the STA device continues the communication with the AP in the secondary channel at 414.

It is noted that in some implementations the STA device may perform fewer or more operations than those illustrated in flowchart 400. For example, a STA device may receive a third control frame in addition to the second control frame prior to or during the UL/DL communication with the AP. As another example, a DSO STA may make multiple transitions across channels in the secondary channel before, during, or after the UL/DL communication with the AP.

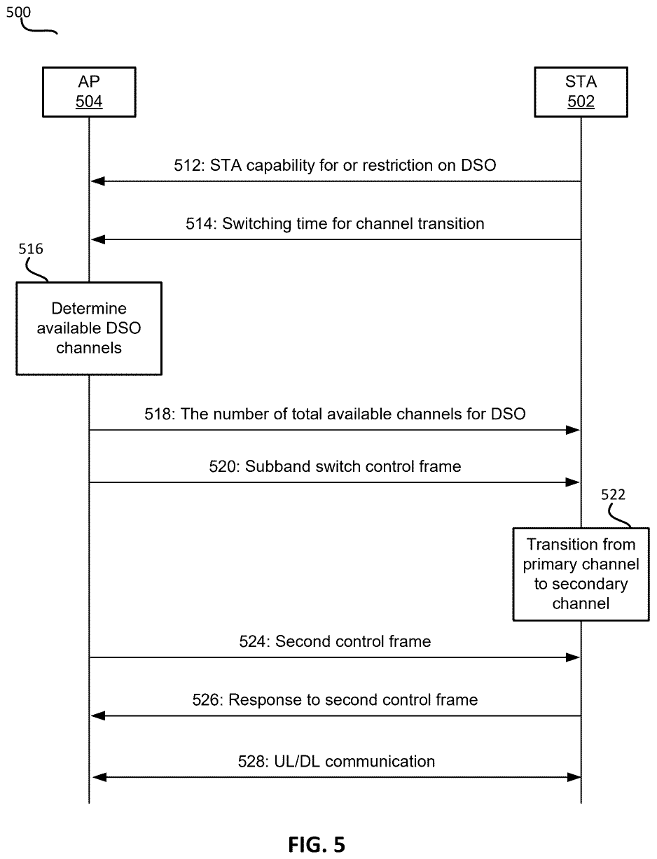

FIG. 5 is a signal diagram 500 that illustrates communications between AP 504 and STA device 502 in DSO, according to some implementations. One or more of the illustrated communications may be similar to the operation described with reference to FIGS. 1-4.

At 512, STA device 502 indicates to AP 504 a capability for or a restriction on DSO. For example, STA device 502 may indicate that STA device 502 is capable of supporting DSO. Alternatively or additionally, STA device 502 may indicate that the channel in the secondary channel after the DSO must be within a certain distance from the primary channel in the frequency domain.

At 512, STA device 502 indicates to AP 504 a minimum switching time used for DSO, such that AP 504 can determine the value of SIFS to allow adequate time for STA device 502 to complete the transitions. For example, based on the indicated minimum switching time, AP 504 determines the number of bits to pad to a control frame to create SIFS. In some implementations, STA device 502 uses different switching times to transition to different channels (including channels in the primary channel and in the secondary channel). In such cases, STA device 502 may indicate multiple minimum switching times and identify the specific channel associated with each minimum switching time. Alternatively or additionally, STA devices with different supported maximum bandwidths may have different switching time settings. In such cases, STA device 502 may specify the supported maximum bandwidths when indicating the switching time setting.

At 516, AP 504 determines available DSO channels. The determination may include determining the total available channels in the secondary channel and/or determining a subset of the total available channels that STA device 502 may transition to. The determination of the subset of the total available channels may follow one or more of the options described previously.

At 518, AP 504 indicates the number of total available channels in the secondary channel to STA device 502.

At 520, AP 504 sends a subband switch control frame to STA device 502. The subband switch control frame may indicate the number of the determined subset of channels, and may identify each of the channels in the subset.

At 522, STA device 502 performs DSO by transitioning from the primary channel to the secondary channel in response to the subband switch control frame.

At 524, AP 504 sends a second control frame to STA device 502, which, at 526, sends back a response to AP 504. The transmission of the subband switch control frame and the second control frame may be separated by a time offset that is no shorter than SIFS, determined by AP 504 based on the switching time indicated at 514. STA device 502 receives the second control frame and transmits the response in the secondary channel.

At 528, AP 504 and STA device 502 communicate with each other in the secondary channel, e.g., by exchanging UL/DL OFDMA symbols.

It is noted that not all operations in signal diagram 500 are required in every implementation. For example, operations at 512 and 514 may be omitted or combined in some implementations. Also, some implementations may have more operations than those illustrated in signal diagram 500. For example, in some implementations, AP 504 may send more than one control frames before, during, or after the communications at 528.

AP 504 may configure STA device 502 with DSO channels statically or dynamically. To statically configure the DSO channels, AP 504 may determine the subset of channels in the secondary channel, indicate the determined channels via the subband switch control frame, and keep communicating with STA device 502 in the same indicated channels without further updates. To statically configure the DSO channels, AP 504 may perform updated determinations of the subset of channels during the communication (e.g., at 528) with AP 504 and dynamically update STA device 502 with the newly-determined number of channels, e.g., via one or more control frames. Example control frames include ICF, such as multi-user request-to-send (MU-RTS) frames or buffer status report poll (BSRP) frames. Upon receiving each of the control frames, STA device 502 may perform another round of DSO by transitioning to a different channel accordingly.

Implementations described above achieve a balance between the need for DSO and the complexity of the network. For example, by limiting the DSO channels to a subset of the total available channels, the sounding overhead for a 20 MHz DSO STA (excluded according to existing DSO restrictions) may be reduced to a level similar to that for an 80 MHz DSO STA, and the demand for processing and storage capacity of the DSO STA is also limited. Additionally, by allowing 80 MHz APs (excluded according to existing DO restrictions) to operate with DSO, a large number of APs may benefit from the increase in channel utilization efficiency due to DSO. With more APs and STA devices able to perform DSO, implementations of this disclosure improve upon existing communications technologies by providing higher efficiency and lower congestion in wireless networks.

In the above description, some portions of the detailed description are presented in terms of algorithms and symbolic representations of operations on signals or data bits within a non-transitory storage medium. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

The description includes references to the accompanying drawings, which form a part of the detailed description. The drawings show illustrations in accordance with exemplary implementations. These implementations, which may also be referred to herein as “examples,” are described in enough detail to enable those skilled in the art to practice the implementations of the claimed subject matter described herein. The implementations may be combined, other implementations may be utilized, or structural, logical, and electrical changes may be made without departing from the scope and spirit of the claimed subject matter. It should be understood that the implementations described herein are not intended to limit the scope of the subject matter but rather to enable one skilled in the art to practice, make, and/or use the subject matter.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “generating,” “providing,” “maintaining,” “charging,” or the like, refer to the actions and processes of an integrated circuit (IC) controller, or similar electronic device, that manipulates and transforms data represented as physical (e.g., electronic) quantities within the controller's registers and memories into other data similarly represented as physical quantities within the controller memories or registers or other such information non-transitory storage medium.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations.

That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such.

Implementations described herein may also relate to an apparatus (e.g., an AP or an STA device) having a processor and a memory, with the processor configured to execute instructions stored in the memory for performing the operations herein. This apparatus may be specially constructed for the required purposes, or it may include firmware or hardware logic selectively activated or reconfigured by the apparatus. Such firmware may be stored in a non-transitory computer-readable storage medium, such as, but not limited to, read-only memories (ROMs), random access memories (RAMs), EPROMs, EEPROMs, flash memory, or any type of media suitable for storing electronic instructions. The term “computer-readable storage medium” should be taken to include a single medium or multiple media that store one or more sets of instructions. The term “computer-readable medium” shall also be taken to include any medium that is capable of storing, encoding, or carrying a set of instructions for execution by the machine and that causes the machine to perform any one or more of the methodologies of the present implementations. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present implementations.

The above description sets forth numerous specific details such as examples of specific systems, components, methods, and so forth, in order to provide a good understanding of several implementations of the present disclosure. It is to be understood that the above description is intended to be illustrative and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method of dynamic subband operation (DSO), comprising:
receiving, by a station (STA) device, a subband switch control frame that indicates a transition, by the STA device, to a secondary channel; and
transitioning, by the STA device, from a primary channel to the secondary channel in response to receiving the subband switch control frame,
wherein the subband switch control frame indicates one or more channels in the secondary channel, and wherein the one or more channels are a subset of total available channels in the secondary channel.

2. The method of claim 1, wherein the subband switch control frame comprises a number of the one or more channels that is smaller than a number of the total available channels in the secondary channel.

3. The method of claim 1, wherein the one or more channels are distributed in the secondary channel according to a basic service set (BSS) associated with the STA device.

4. The method of claim 3, wherein the one or more channels are distributed in the secondary channel according to a maximum bandwidth of the STA device supported by the BSS.

5. The method of claim 1, wherein the one or more channels are distributed in the secondary channel according to a maximum bandwidth of an access point (AP) and a fixed number.

6. The method of claim 1, further comprising:
receiving, from an access point (AP), a first message indicating a number of the total available channels for the DSO.

7. The method of claim 6, wherein the first message comprises at least one of: a beacon prior to a network attach procedure, or a capability message during the network attach procedure.

8. The method of claim 6, further comprising receiving a second message indicating a dynamic update of the number of the total available channels for the DSO.

9. The method of claim 1, further comprising:
transmitting, to an access point (AP), a third message indicating at least one of: a capability of the STA device to support the DSO, or a restriction on transitioning from the primary channel to the secondary channel.

10. The method of claim 1, further comprising:
transmitting, to an access point (AP), a fourth message indicating a switching time to transition from the primary channel to the secondary channel.

11. The method of claim 1, wherein the STA device supports a maximum bandwidth of 20 mega-Hertz (MHz) or 40 MHz.

12. A method of dynamic subband operation (DSO), comprising:
determining, by an access point (AP), one or more channels in a secondary channel; and
transmitting, to a station (STA) device, a subband switch control frame that causes the STA device to transition from a primary channel to the one or more channels in the secondary channel,
wherein the one or more channels are a subset of total available channels in the secondary channel.

13. The method of claim 12, wherein the subband switch control frame comprises a number of the one or more channels that is less than a number of the total available channels in the secondary channel.

14. The method of claim 12, wherein the one or more channels are distributed in the secondary channel according to a basic service set (BSS) associated with the STA device.

15. The method of claim 12, wherein the one or more channels are distributed in the secondary channel according to a maximum bandwidth of the AP and a fixed number.

16. The method of claim 12, further comprising:
transmitting, to the STA device, a first message indicating a number of the total available channels for the DSO.

17. The method of claim 16, further comprising: transmitting, to the STA device, a second message indicating a dynamic update of the number of the total available channels for the DSO.

18. The method of claim 12, further comprising:
receiving, from the STA device, a third message indicating at least one of: a capability of the STA device to support the DSO, or a restriction on transitioning from the primary channel to the secondary channel.

19. The method of claim 12, further comprising:
receiving, from the STA device, a fourth message indicating a switching time to transition from the primary channel to the secondary channel; and
determining, based on the fourth message, a padding of the subband switch control frame.

20. An apparatus comprising:
a memory; and
a processor, operatively coupled to the memory, to:
receive a subband switch control frame that indicates a transition to a secondary channel; and
transition from a primary channel to the secondary channel in response to receiving the subband switch control frame,
wherein the subband switch control frame indicates one or more channels in the secondary channel, and wherein the one or more channels are a subset of total available channels in the secondary channel.
